(19) United States
(12) Patent Application Publication
(10) Pub. No.: US 2015/0019130 A1
(43) Pub. Date: Jan. 15, 2015

(54) Dual Function Focal Plane Array Seeker

(71) Applicant: ROSEMOUNT AEROSPACE INC., BURNSVILLE, MN (US)

(72) Inventors: Robert D. Rutkiewicz, Edina, MN (US); Todd A. Ell, Savage, MN (US)

(21) Appl. No.: 13/937,636

(22) Filed: Jul. 9, 2013

(51) Int. Cl. G01S 17/46; F42B 15/01; G01S 7/481

(52) U.S. Cl. CPC G01S 17/46; G01S 7/4816; F42B 15/01
USPC 701/519; 356/614

(57) ABSTRACT

A system and method of tracking an object is disclosed. Light is received from the object at a lens having an optical axis, a non-linear off-axis (peripheral) portion and an on-axis portion. The received light is directed onto a photodetector array via the non-linear peripheral portion of the lens. A direction of the object with respect to an optical axis of the lens is determined from a location of the light on the photodetector array. The determined direction is used to orient the optical axis of the lens toward object to track the object. The photodetector array and lens may be coupled to a projectile and the determined direction may be used to direct the projectile to hit a target.

### BACKGROUND

The present invention relates to systems for tracking an object and in particular to systems and methods for orienting an optical tracking system toward an off-axis object.

Laser designation technologies used in munitions guidance systems use a laser to illuminate an intended target, often up to the point of the munitions impact with the target. These technologies may include an optical tracking system for providing linear image resolution of the target. Linear image resolution is generally limited to those targets that are already on or near an optical axis of the optical tracking system.

### SUMMARY

According to one embodiment of the present disclosure, a method of tracking an object includes: receiving light from the object at a lens, the lens having an optical axis, a non-linear peripheral portion and a linear on-axis portion; directing light received from the object onto a photodetector array via the non-linear peripheral portion of the lens; determining a direction of the object with respect to the optical axis of the lens from a location of the light on the photodetector array; and using the determined direction to orient the optical axis of the lens toward the object to track the object.

According to another embodiment of the present disclosure, a system for tracking an object includes: a photodetector array for receiving light from the object; a lens having a non-linear peripheral portion away from an optical axis of the lens for directing light received from the object onto the photodetector array; and a processor configured to: determine a direction of the object with respect to the optical axis from a location on the photodetector array of the light directed onto the photodetector array through the non-linear peripheral portion of the lens, and use the determined direction to orient the optical axis of the lens toward the object to track the object.

According to another embodiment of the present disclosure, a method of directing a projectile to hit a target includes: receiving light from the target at a lens coupled to the projectile, the lens having an optical axis, a non-linear peripheral portion and an on-axis portion; directing light received from the target onto a photodetector array coupled to the projectile via the non-linear peripheral portion of the lens; determining a direction of the target with respect to a direction of the projectile from a location of the light on the photodetector array; and using the determined direction to orient the projectile towards the target

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an optical tracking system in an exemplary embodiment of the present invention;

FIG. 2 shows several views of a focal plane array of the exemplary tracking system of FIG. 1; and

FIGS. 3 and 4 illustrate various uses of the optical tracking system of FIG. 1 to track a target.

### DETAILED DESCRIPTION

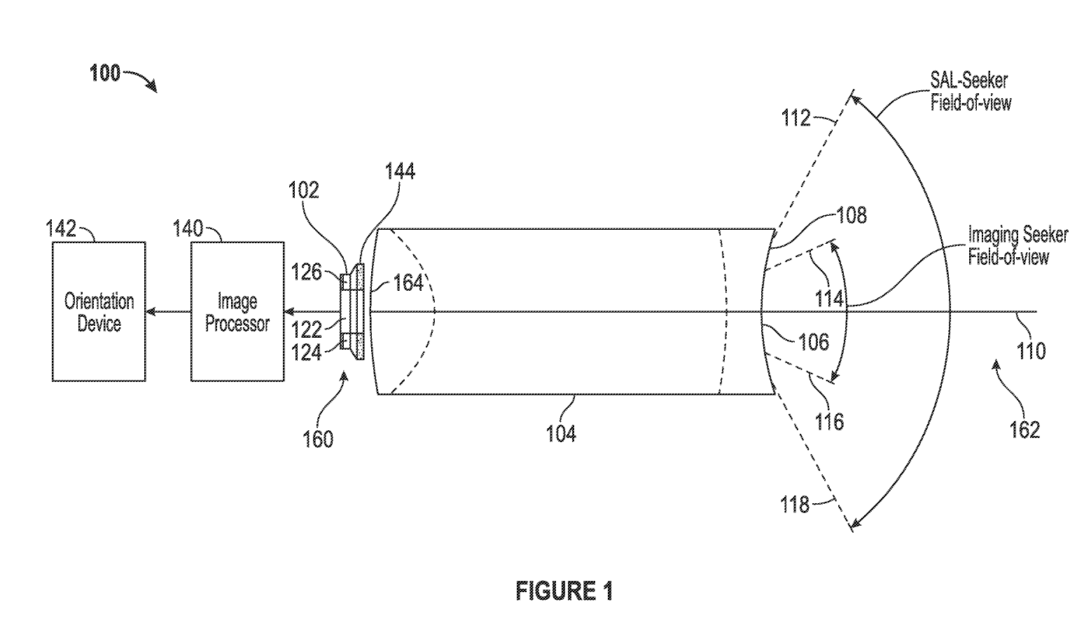

FIG. 1 shows an optical tracking system 100 according to one embodiment. The illustrated optical tracking system 100 may be disposed on a missile or other projectile for striking a target. The illustrated tracking system 100 includes a focal plane array 102 that includes an array of photodetectors (also referred to herein as pixels). The pixels may be arranged in a substantially lattice pattern such as a square pattern. A lens 104 is placed in front of the focal plane array 102 such that the focal plane array 102 is located substantially at a focal point of the lens 104 in an image space 160 of the lens 104. The lens 104, therefore, focuses light from an object in an object space 162 of the lens 104 onto the focal plane array 102. The lens 104 may be a wide-angle foveated lens. Proximate the image space 160, the lens 104 may include an optical surface 164 for focusing light at the focal plane array 102. Proximate the object space 162, the lens 104 includes a linear (on-axis) optical surface 106 along an optical axis 110 of the lens 104 and a peripheral (off-axis) optical surface 108. The linear optical surface 106 includes an optical surface suitable for providing an image at the focal plane array 102 suitable for image resolution. The peripheral optical surface 108 includes a non-linear optical surface that provides a wide-angle viewing range capability for the optical tracking system 100. In an exemplary embodiment, the linear optical surface 106 and the peripheral optical surface 108 are formed on a single lens 104. Due to the wide-angle viewing capabilities of the peripheral optical surface 108, images of objects viewed via the peripheral optical surface 108 are general too small for image resolution at the focal plane array 102. Light passing through the peripheral optical surface 108 may nonetheless be detected at the focal plane array 102 and used to detect a direction of an object with respect to the optical tracking system 100 using the methods disclosed herein.

A field of view for the linear optical surface 106 is defined by the angle between lines 114 and 116. In various embodiments, this angle is about 20° to about 30° (or about 10° to about 15° as measured from the optical axis 110). Light passing through the linear optical surface 106 illuminates a central region 122 on the focal plane array 102.

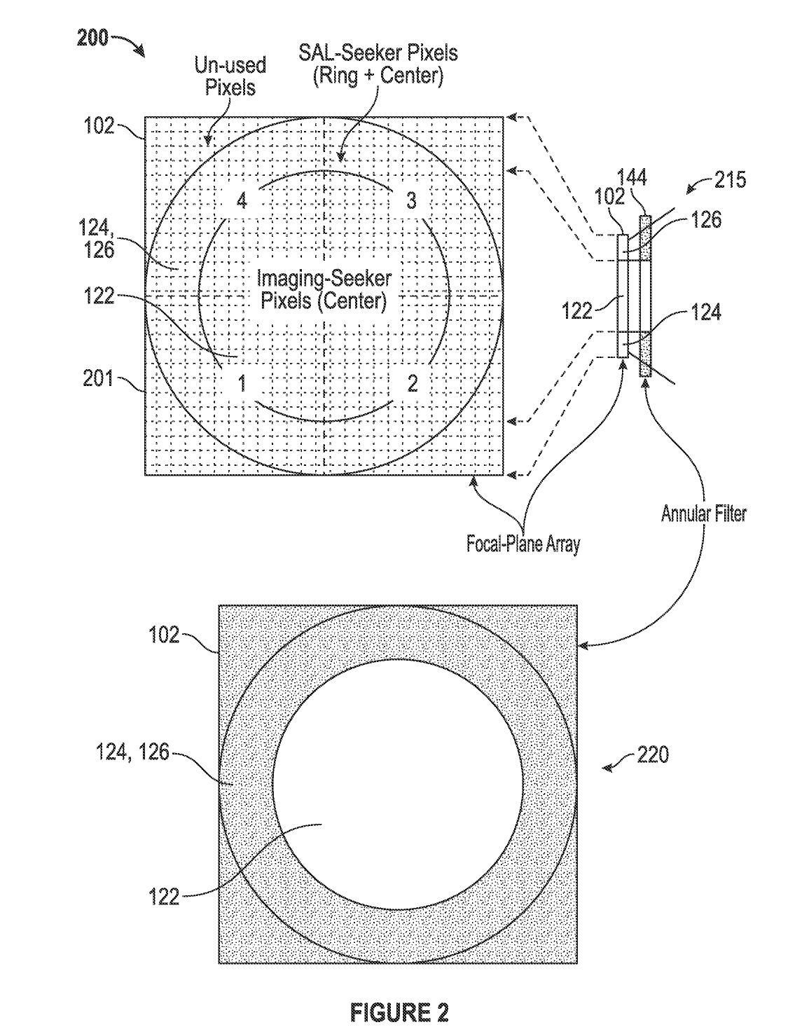

A field-of-view for the peripheral optical surface 108 is defined by the angle between lines 112 and 114 or, alternately, by the angle between lines 116 and 118. In various embodiments, due to the symmetry of the optical tracking system 100, lines 112 and 118 are rotationally invariant and lines 114 and 116 are rotationally invariant. Thus, the angle between lines 112 and 114 is the substantially same as the angle between lines 116 and 118. Light passing through the peripheral optical surface 108 between lines 112 and 114 illuminates region 124 of the focal plane array 102. Light passing through peripheral optical surface 108 between lines 116 and 118 illuminates region 126 of the focal plane array 102. As seen with respect to FIG. 2, region 124 and region 126 are subsections of an annular region (124,146) at the focal plane array 102.

The field of view for the entire lens 104 is defined by the angle between lines 112 and 118. In an exemplary embodiment, the angle between line 112 and line 118 is about 80° to about 100° or (as measured between the optical axis 110 and either of line 112 and 118) about 40° to about 50°.

In another embodiment, the peripheral optical surface 108 may have an overall angular field-of view in a range from about 60 degrees to about 120 degrees and the linear optical surface 106 may have an angular field-of-view in a range from about 30 to about 60 degrees.

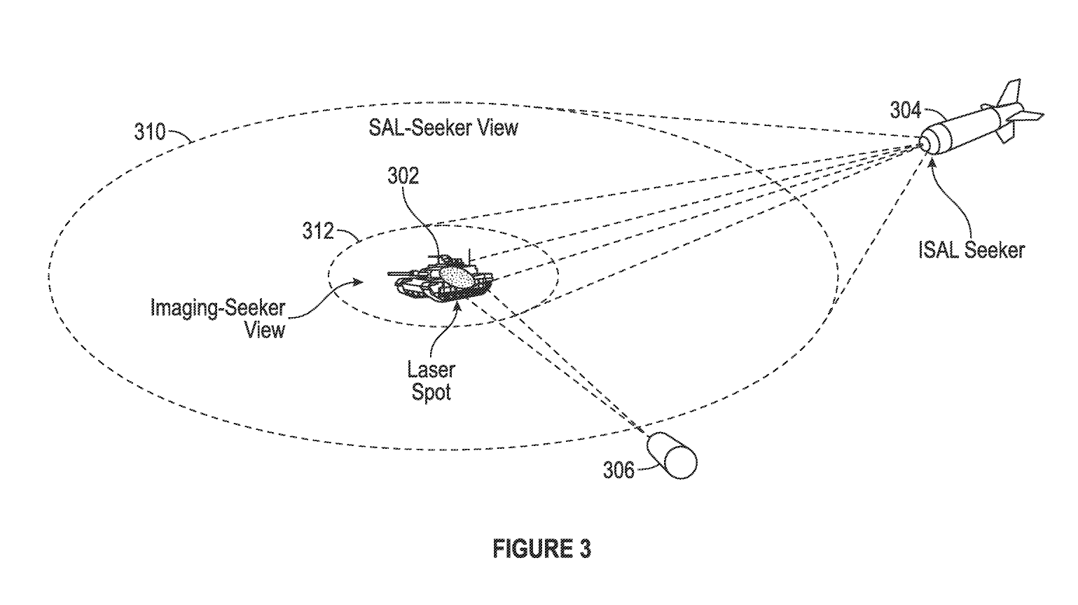

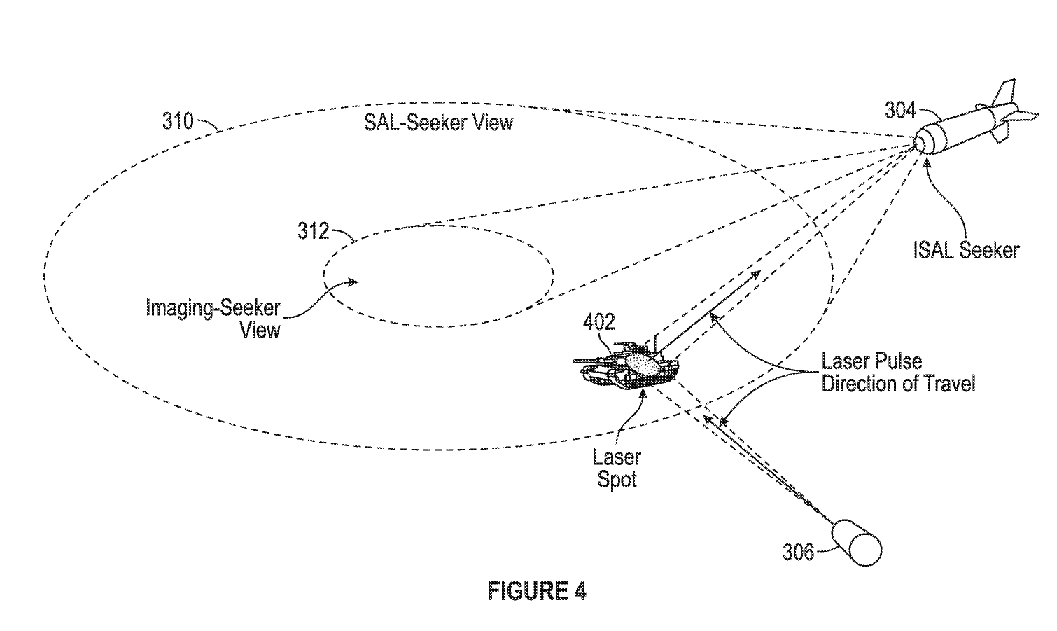

An annular filter 144 may be placed between the lens 104 and the focal plane array 102. The annular filter 144 may filter light that passes through the peripheral optical surface 108 of the lens 104. Light passing through the linear surface 106 is generally unfiltered by annular filter 144. For peripheral light, the annular filter 144 may include a narrow-band filter that filters out the frequencies of ambient sunlight and allows the frequency of a selected laser (see laser 306 in FIGS. 3 and 4) to pass through unfiltered in order to improve methods of target detection discussed below.

A processor 140 is coupled to the focal plane array 102 and is configured to obtain signals from the pixels of the focal plane array 102. In one aspect, the processor 140 determines from the obtained signals a direction of an object with respect to the optical tracking system 100 and thus with respect to the direction of the projectile being guided by the optical tracking system 100. The processor 140 uses the determined direction of the object to operate an orientation device 142 to re-orient the tracking system 100 and/or the projectile towards the direction of the object.

FIG. 2 shows several views of the focal plane array 102 of the exemplary tracking system 100. Annular filter 144 is shown in front of the focal plane array 102 in a side view 215. The exemplary face 200 receives the light directed onto the focal plane array 102 by the lens 104 of FIG. 1. As shown in a first head-on view 200 of the focal plane array 102, the face 201 of the focal plane array 102 includes an array of pixels, as indicated by individual squares, such as exemplary pixel 202. A back side of the pixels 202 may be coupled to processor 140 of FIG. 1 and provide signals to the processor 140. Shown on the face 201 is a central region 122 defined by the linear optical surface 106 and an annular region (124, 146) defined by peripheral optical surface 108 of lens 104. Light that passes through linear optical surface 106 illuminates pixels in central region 122. The central region 122 generally corresponds to the central region 122 defined by lines 114 and 116 in FIG. 1. Light that passes through the peripheral optical surface 108 are focused on pixels in the annular region (122, 124). The annular region (124,126) is defined by lines 112 and 114 and lines 116 and 118 of FIG. 1. A set of pixels in corner regions 208 generally do not receive light from either the linear optical surface 106 or the peripheral optical surface 108 and thus are unused. FIG. 2 also shows a second head-on view 220 of the focal plane array 102 illustrating the effect of the annular filter 144 at the focal plane array 102. Annular region (122,124) receives filtered light and central region 122 receives unfiltered light.

FIGS. 3 and 4 illustrate various uses of the optical tracking system 100 of FIG. 1 in tracking a target. In an exemplary embodiment, optical tracking system 100 may be operated in at least two modes. FIG. 3 illustrates a first tracking mode of the optical tracking system 100 in which a target 302 is overtly tracked by a missile or weapon 304 that includes the optical tracking system 100 to hit the target 302. The first tracking mode may be an overt tracking mode, also referred to as an image-based tracking mode. A laser 306 or suitable light source may be directed onto the target 302 and a reflection of the laser beam from the selected target 302 is collected at the lens 104 and directed onto the central region 122 of the focal plane array 102. In various embodiments, the laser 306 generates a laser beam in a short wave infrared (SWIR) spectrum (from about 1.4 micrometers (μm) to about 3 μm). The focal plane array 102 is therefore also sensitive to the SWIR spectrum.

In the overt tracking mode, light received at the focal plane array 102 is used as input to an image-recognition program run at the processor 140 in order to direct the projectile toward the target 302. In general, this image-based tracking mode is used on object 302 located in region 312. Due to the ability of the target 302 to be image effectively at the focal plane array 102, illumination of the target by laser 306 may not be necessary in the overt tracking mode.

In FIG. 3, target 302 is substantially in front of or in a line of sight of the tracking system 100 (i.e., substantially along or near the optical axis 110 of lens 104). FIG. 3 further shows a second region 310 surrounding the first region 312. Light from objects in first region 310 pass through the linear optical surface 106 and is focused at central region 122 of the focal plane array 102. Light from the second region 310 passes through the peripheral optical surface 108 of lens 104 and is generally mapped to annular region (124, 126) in FIG. 2. Objects in this second region 310 may be tracked using a laser-designation mode as discussed in FIG. 4.

FIG. 4 illustrates a second mode of operation of the optical tracking system 100. The second mode of operation may be referred to herein as a covert tracking mode or a laser-designation tracking mode. In covert tracking mode, the missile 304 is not currently oriented toward the target 402. The covert tracking mode of operation may use laser-designation tracking and may be used primarily for orienting the optical tracking system 100 toward a target 402 that is substantially to the side of the optical tracking system (i.e., in second region 310). However, the covert tracking mode may also be used for target 302 in first region 310 of FIG. 3 in various embodiments. Referring back to FIG. 4, the image of target 402 formed at the focal plane array 202 may be too small or may have too low a resolution for image-based tracking to be used. However, the image of target 402 is mapped to the annular region (124, 126) and the intensity of the image of the target 402 may be used to track the target 402, as discussed below.

Referring again to FIG. 2, in a laser-designation tracking mode, the face 201 may be divided into four quadrants, labeled in FIG. 2 as Quadrant 1, Quadrant 2, Quadrant 3 and Quadrant 4. In alternate embodiments, the face 201 may be divided into any number of regions suitable for use with the methods disclosed herein. In an exemplary embodiment, the processor 140 is configured to sum signal strengths (also referred to herein as “signal intensities”) for the pixels from a selected quadrant in order to obtain total signal strength for the selected quadrant. The processor 140 then determines which of the four quadrants receives the laser light reflected off of the target from the summed intensities. Since the laser-designation tracking mode relies upon a summation of signal strengths over a quadrant of the face 201, the formation of an image is not a necessary aspect of the laser-designation tracking mode.

An exemplary method for a laser-designation tracking mode is described below. The processor sums the signal strengths for the pixels of each of the four quadrants to obtain total signal strength for each of the four quadrants. The total signal strength values for the quadrants may be compared to each other to determine which quadrant has the greater signal strength. This determination may then be used to steer the projectile toward its designated object so that the lens and photodetector array are aligned with the designated object and light from the designated object passes through the linear linear surface of the lens. In one embodiment, a difference between the values of selected quadrants may be determined and the sign (plus or minus) of the difference may be used to determine a direction in which to re-orient of the projectile. In one embodiment, summed intensities for the left half (i.e., quadrants 1 and 4) and right half (i.e., quadrants 2 and 3) of the face 201 may be compared to each other to determine steering along the horizontal plane of the photodetector array. In another embodiment, summed intensities for the upper half (i.e., quadrants 3 and 4) and lower half (i.e., quadrants 1 and 2) may be compared to each other to determine steering along the vertical plane of the photodetector array. In addition, a peak or maximum pixel value may be obtained. In various embodiments, a gradient of the pixel values may be determined and used to determine a re-orientation direction. The method disclosed above for the laser-designation tracking mode may be used as part of a control loop to continuously guide the projectile toward the designated target.

In an alternate embodiment, the processor 140 may operate in both the laser-designation tracking mode and the image-based tracking mode. When the summed signal strengths for each of the quadrants are balanced in the laser-designation tracking mode, the optical tracking system 100 is centered on the target. This provides an opportunity for the processor 140 to end the laser-designated tracking mode in to switch to the image-based tracking mode.

It may be noted that the laser-designated tracking mode may be used for images formed in either the central region 122 of the annular region (124, 126), while the image-based tracking mode is generally used when the images is formed in the central region 122.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of tracking an object, comprising:
receiving light from the object at a lens, the lens having an optical axis, a non-linear peripheral portion and an on-axis portion;
directing light received from the object onto a photodetector array via the non-linear peripheral portion of the lens;
determining a direction of the object with respect to the optical axis of the lens from a location of the light on the photodetector array; and
using the determined direction to orient the optical axis of the lens toward the object to track the object.

2. The method of claim 1, wherein determining the direction of the object further comprises summing signal intensities for at least two segments of the photodetector array and determining the direction of the object with respect to the optical axis from a difference in the summed intensities.

3. The method of claim 2, wherein the at least two segments further comprise two quadrants of the photodetector array.

4. The method of claim 2, further comprising comparing summed intensities in a first half of the photodetector array to summed intensities in a second half of the photodetector array to determine the direction.

5. The method of claim 1, wherein the non-linear peripheral portion of the lens is shaped to project light from the object into a region along a perimeter of the photodetector array when the photodetector array is at a focal plane of the on-axis surface of the lens.

6. The method of claim 1, further comprising illuminating the object with a light source to produce a reflected light for detection at the photodetector array.

7. The method of claim 6, wherein the light source further includes a laser generating light in the short-wave infrared spectrum.

8. A system for tracking an object, comprising:
a photodetector array for receiving light from the object;
a lens having a non-linear peripheral portion away from an optical axis of the lens for directing light received from the object onto the photodetector array; and
a processor configured to:
determine a direction of the object with respect to the optical axis from a location on the photodetector array of the light directed onto the photodetector array through the non-linear peripheral portion of the lens, and
use the determined direction to orient the optical axis of the lens toward the object to track the object.

9. The system of claim 8, wherein the processor is further configured to determine the direction of the object by summing signal intensities for at least two segments of the photodetector array and determining a difference in the power terms.

10. The system of claim 9, wherein the at least two segments further comprise two quadrants of the photodetector array.

11. The system of claim 9, wherein the processor is further configured to compare summed intensities in a first half of the photodetector array to summed intensities in a second half of the photodetector array to determine the direction.

12. The system of claim 8, wherein the peripheral portion of the lens is shaped to project light from the object into a region along a perimeter of the photodetector array when the photodetector array is at a focal plane of the on-axis surface of the lens.

13. The system of claim 8, further comprising a light source configured to illuminate the object to produce a reflected light for direction onto the photodetector array.

14. The system of claim 13, wherein the light source further includes a laser generating light in the short-wave infrared spectrum.

15. A method of directing a projectile to hit a, comprising:
receiving light from the target at a lens coupled to the projectile, the lens having an optical axis, a non-linear peripheral portion and an on-axis portion;
directing light received from the target onto a photodetector array coupled to the projectile via the non-linear peripheral portion of the lens;
determining a direction of the target with respect to a direction of the projectile from a location of the light on the photodetector array; and
using the determined direction to orient the projectile towards the target.

16. The method of claim 15, wherein determining the direction of the target further comprises summing signal intensities for at least two segments of the photodetector array and determining the direction of the target with respect to the direction of the projectile from a difference in the summed intensities.

17. The method of claim 16, wherein the at least two segments further comprise two quadrants of the photodetector array.

18. The method of claim 16, further comprising comparing summed intensities in a first half of the photodetector array to summed intensities in a second half of the photodetector array to determine a steering direction.

19. The method of claim 15, further comprising illuminating the target with a light source to produce a reflected light for detection at the photodetector array.

20. The method of claim 15, wherein the light source further includes a laser generating light in the short-wave infrared spectrum.
